(19) United States
(12) Patent Application Publication
(10) Pub. No.: US 2018/0037429 A1
(43) Pub. Date: Feb. 8, 2018

(54) PAPER SHEET HANDLING APPARATUS

(71) Applicant: GLORY LTD., Himeji-shi, Hyogo (JP)

(72) Inventors: Tsuyoshi HODATSU, Hyogo (JP); Takaaki IMOTO, Hyogo (JP); Yoshinori NAITOU, Hyogo (JP)

(73) Assignee: GLORY LTD., Himeji-shi, Hyogo (JP)

(21) Appl. No.: 15/552,043

(22) PCT Filed: Feb. 17, 2016
(86) PCT No.: PCT/JP2016/054626

§ 371 Date: Aug. 18, 2017

(30) Foreign Application Priority Data
Feb. 19, 2015 (JP) 2015-030230

(51) Int. Cl. B65H 7/06; G07D 11/00; B65H 29/22; B65H 29/24; B65H 9/10

(52) U.S. Cl. CPC B65H 7/06; B65H 29/246; B65H 9/101; B65H 29/22; G07D 11/0084; B65H 2701/1912

(57) ABSTRACT

One object is to provide a paper sheet handling apparatus in which a paper sheet stacked in a stacking unit is surely pushed toward an opening in the stacking unit. The paper sheet handling apparatus includes a feed unit that feeds a paper sheet, a transport unit that transports the paper sheet fed by the feed unit, a stacking unit that stacks therein the paper sheet transported by the transport unit and has an opening for removing the paper sheet stacked therein, a pushing member that pushes the paper sheet present in the stacking unit toward the opening, a pressing member that presses the paper sheet pushed by the pushing member, and a control unit that controls driving the pressing member based on an operation of the pushing member.

### TECHNICAL FIELD

The present invention relates to a paper sheet handling apparatus that performs recognition and counting of a paper sheet, and stacks the paper sheet.

### BACKGROUND ART

A banknote handling apparatus that performs recognition and counting of banknotes, and stacks those banknotes in a stacking unit is known in the art. Some stacking units that allow stacking of a plurality of banknotes have an opening for removing the banknotes stacked therein. In the stacking unit having such an opening, it is desirable that a banknote is surely stacked without the banknote being jumping outside of the opening and that the banknote stacked inside is easily removable. For example, Patent Document 1 discloses a banknote handling apparatus in which a pushing member is provided in a stacking unit, and the banknote stacked in the stacking unit is pushed by this pushing member toward the opening. Accordingly, the banknote can be surely stacked deep inside the stacking unit when viewed from the opening, and by pushing the stacked banknote toward the opening with the pushing member, it becomes easy to remove the banknote from the opening.

### CITATION LIST

### Patent Document

[Patent Document 1] PCT Publication No. WO 2009/028072

### SUMMARY OF INVENTION

### Technical Problem

However, in the conventional technology, the banknote may not be surely pushed by the pushing member. Specifically, when the banknote is pushed inside the stacking unit, a part of the banknote may be caught in bumps and dents, structural members, and the like present inside the stacking unit. Particularly, a banknote in a bad condition, such as a banknote stacked in a folded manner or a torn note, is sometimes not pushed as it is caught in the bumps and dents and the like present inside the stacking unit.

The present invention is made to address the problems in the conventional technology. One object of the present invention is to provide a paper sheet handling apparatus that can surely push a paper sheet stacked in a stacking unit toward an opening provided for removing the paper sheet.

### Means for Solving Problems

To solve the above problems and to achieve the above object, a paper sheet handling apparatus according to one aspect of the present invention includes a feed unit that feeds a paper sheet; a transport unit that transports the paper sheet fed by the feed unit; a stacking unit for stacking therein the paper sheet transported by the transport unit and having an opening for removing the paper sheet stacked therein; a pushing member that pushes the paper sheet present in the stacking unit toward the opening; a pressing member that presses the paper sheet pushed by the pushing member; and a control unit that controls driving the pressing member based on an operation of the pushing member.

In the above paper sheet handling apparatus, while the pushing member is pushing the paper sheet, the pressing member presses the paper sheet in a direction that is orthogonal to a pushing direction of the pushing member.

In the above paper sheet handling apparatus, the pressing member is a rotating member that is used for stacking the paper sheet inside the stacking unit. The rotating member presses the paper sheet while rotating.

In the above paper sheet handling apparatus, the rotating member is a stacking wheel. When stacking the paper sheet, while the stacking wheel rotates, the stacking wheel receives between blades the paper sheet transported by the transport unit to discharge and stack in the stacking unit. When pressing the paper sheet, while the stacking wheel rotates, the stacking wheel presses the paper sheet being stacked inside the stacking unit in a direction going away from the stacking wheel.

In the above paper sheet handling apparatus, the rotating member includes a shaft member supported on a rotation axis; an arm member that extends in a diameter direction of the shaft member; and a patting member arranged at a far tip end in a diameter direction of the arm member.

In the above paper sheet handling apparatus, the control unit controls a rotational frequency of the rotating member.

In the above paper sheet handling apparatus, the control unit changes the rotational frequency of the rotating member between when stacking the paper sheet in the stacking unit and when pressing the paper sheet pushed by the pushing member.

In the above paper sheet handling apparatus, the control unit controls a rotation direction of the rotating member.

In the above paper sheet handling apparatus, the pushing member and the pressing member are drivable while the transport unit is not operated.

The above paper sheet handling apparatus further includes a first driving mechanism for driving the transport unit; a second driving mechanism for driving the pushing member; and a third driving mechanism for driving the pressing member.

In the above paper sheet handling apparatus, a plurality of the stacking units are provided. The pushing member and the pressing member are provided in each of the stacking units. The control unit separately controls driving each of the pushing members and each of the pressing members.

The above paper sheet handling apparatus further includes an operation unit that receives an instruction operation. The control unit controls driving the pushing member and the pressing member based on the instruction operation received in the operation unit.

In the above paper sheet handling apparatus, the control unit controls driving the pushing member and the pressing member based on a status of paper sheet handling.

In the above paper sheet handling apparatus, the pressing member moves between a pressing position at which the pressing member presses the paper sheet present inside the stacking unit and a retracted position at which the pressing member is retracted from inside of the stacking unit. The control unit controls moving the pressing member to the retracted position while a banknote is being stacked in the stacking unit and moving the pressing member from the retracted position to the pressing position when the pushing member pushes the paper sheet.

In the above paper sheet handling apparatus, a part of the pressing member in contact with the paper sheet is constituted by an elastic member.

In the above paper sheet handling apparatus, a part of the pressing member in contact with the paper sheet is constituted by a rotating member rotatable in a direction of pushing of the paper sheet by the pushing member.

In the above paper sheet handling apparatus, the pressing member presses the paper sheet by applying wind pressure on the paper sheet.

The above paper sheet handling apparatus further includes a detection unit that detects a stacking state of the paper sheet stacked in the stacking unit. The control unit determines whether pressing of the paper sheet is necessary or not based on a detection result by the detection unit and drives the pressing member when the pressing of the paper sheet is necessary.

### Advantageous Effects of Invention

According to the present invention, in the stacking unit having the opening for removing the paper sheet stacked therein, when the pushing member pushes the stacked paper sheet toward the opening, the paper sheet can be pressed by the pressing member. Even if bumps and dents, structural members, and the like are present inside the stacking unit, by pressing the paper sheet in a direction going away from them, it can be prevented that the paper sheet is caught in the bumps and dents, the structural members, and the like. Accordingly, the pushing of the paper sheet can be performed surely.

### BRIEF DESCRIPTION OF DRAWINGS

FIG. 1 is a perspective view of an external appearance of a banknote handling apparatus according to the present embodiment.

FIG. 2 is a view depicting a structure of a banknote stacking unit.

FIGS. 3A and 3B are perspective views of a structure of a pushing member provided inside the banknote stacking unit and a driving mechanism that moves the pushing member.

FIGS. 4A and 4B are views depicting a retracted position and a pushing position of the pushing member inside the banknote stacking unit.

FIG. 5 is a view depicting an internal structure of the banknote stacking unit.

FIG. 6 is a block diagram of a functional unit that controls operations of stacking wheels that function as a pressing member and operations of the pushing members.

FIG. 7 is a flowchart depicting a flow of a process procedure for pushing a banknote present inside the banknote stacking unit with the pushing member while controlling the rotation of the stacking wheel.

FIG. 8 is a view depicting an example of a stacking wheel provided with a patting member.

FIG. 9 is a view depicting another example of a pressing member arranged pivotably on a roof surface of the stacking unit.

FIG. 10 is a view depicting an example of a pressing member arranged retractably in an opening in a side surface of the stacking unit.

FIG. 11 is a view depicting an example of a pressing member that presses a banknote by wind pressure.

FIG. 12 is a view depicting another example of a pressing member that presses a banknote by wind pressure.

FIG. 13 is a perspective view of an external appearance of a trash tray.

FIGS. 14A to 14C are views depicting a structure of the trash tray.

### DESCRIPTION OF EMBODIMENTS

Exemplary embodiments of a paper sheet handling apparatus according to the present invention are explained in detail with reference to the accompanying drawings. In the paper sheet handling apparatus according to the present invention, as far as the apparatus includes a stacking unit having an opening, a type of paper sheet that can be handled therewith is not particularly limited. An example of a banknote handling apparatus that handles a banknote is explained below.

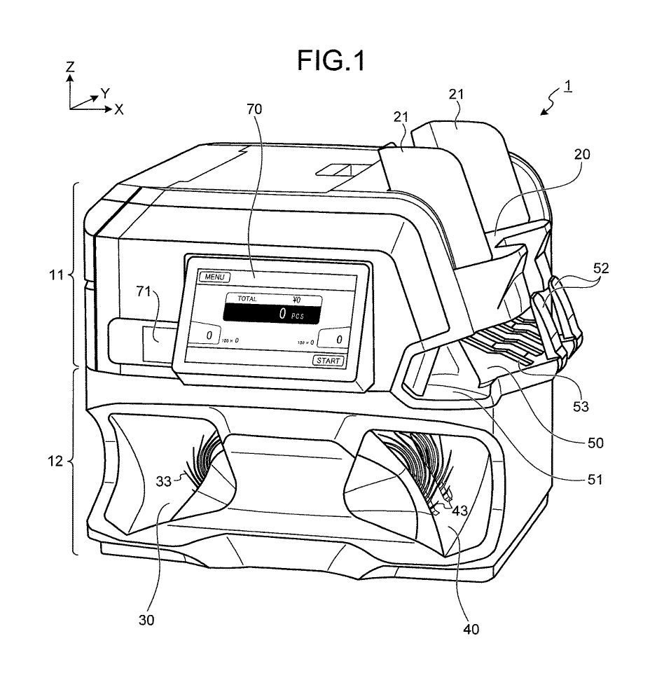

An outline of the banknote handling apparatus (paper sheet handling apparatus) according to the present embodiment is given below. FIG. 1 is a perspective view depicting an external appearance of a banknote handling apparatus 1. The banknote handling apparatus 1 has a hopper 20 and a reject unit 50 arranged on a side surface thereof, and has two banknote stacking units 30 and 40 and an operation/display unit 70 arranged on a front surface thereof. Each of the banknote stacking units 30 and 40 has an opening on a front surface side of the apparatus for removing a banknote stacked therein. The banknote is stacked in an inclined standing state inside the banknote stacking units 30 and 40. Moreover, on the left side of the operation/display unit 70 is arranged a trash tray 71 of a push-open type that comes out toward the front surface side when pushed toward a back surface side of the apparatus. Trash, such as paper dust, that is produced while the banknote is transported by a transport unit on a transport path arranged inside the apparatus, is collected in the trash tray 71. By using the trash tray 71, the trash can be removed from the apparatus.

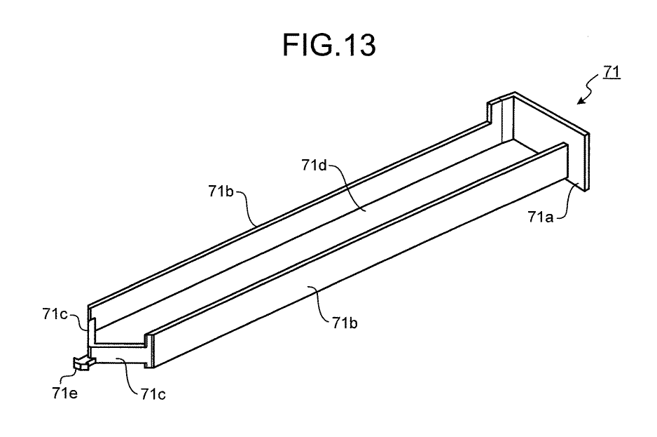

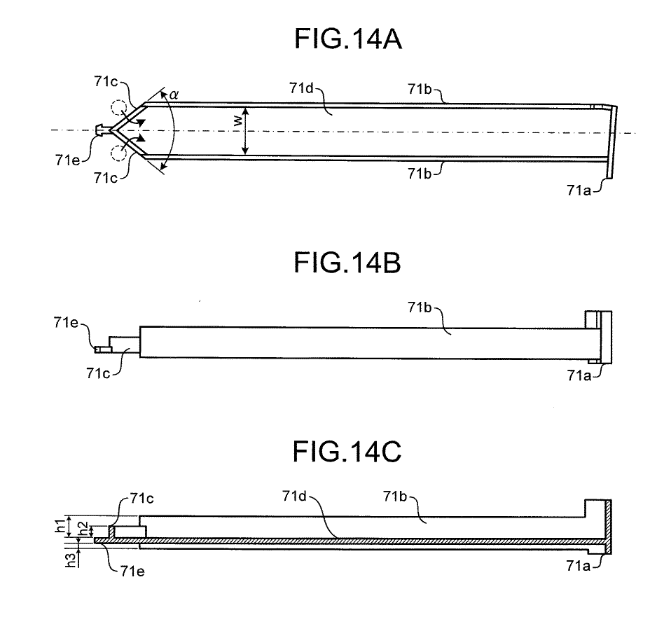

FIG. 13 is a perspective view of an external appearance of the trash tray 71. FIGS. 14A to 14C are views depicting a structure of the trash tray. FIG. 14A is a plan view of the trash tray 71 when seen from above, and FIG. 14B is a side view of the trash tray 71 when seen from the left side of the apparatus (from below in FIG. 14A). Moreover, FIG. 14C is a cross-section taken at a position of a dot-and-dash line shown in FIG. 14A when seen from the left side of the apparatus.

The trash tray 71 includes a front part 71a, side parts 71b, a rear part 71c, a bottom part 71d, and an engaging member 71e. As shown in FIG. 1, the front part 71a constitutes one surface with the front surface of the apparatus when attached to the banknote handling apparatus 1. The side parts 71b are arranged on left and right of the trash tray 71. The rear part 71c is arranged in a shape of a symbol “<” when seen from above. The trash accumulates on a top surface of the bottom part 74d. The engaging member 71e is formed outside of the rear part 71c. The trash tray 71 has a shape of a box with a top surface thereof open. This box, when seen from above, has approximately five-cornered shape including the two side parts 71b that are substantially parallel to each other. The engaging member 71e is arranged at an apex, which is the corner on the rear part 71c, of the approximately five-cornered shape.

The front part 71a, which is substantially plate-shaped, is formed to match with an opening, which is formed on the front surface of the apparatus, so that it constitutes one surface with the front surface of the apparatus, when the trash tray 71 is mounted in the banknote handling apparatus 1. The right side part 71b (upper one in FIG. 14A) is substantially rectangle plate shaped and a part thereof only on the front part 71a side is slightly curved. The left side part 71b is substantially rectangle plate shaped. A height (height in an up-down direction in FIG. 14B) of the side parts 71b is less than a height of the front part 71a. The front part 71a and both the side parts 71b are joined in such a manner that a lower edge of both the side parts 71b contacts a top surface of a plate arranged inside the apparatus when the trash tray 71 is mounted in the apparatus so that the front part 71a constitutes one surface with the front surface of the apparatus. The bottom part 71d, which is the substantially five-cornered shaped plate, is connected to the front part 71a, both the side parts 71b, and the rear part 71c at a slightly upper position from the lower edge of both the side parts 71b. When the trash tray 71 is mounted in the apparatus, the top surface of the bottom part 71d is horizontal and a small gap is secured between the lower surface of the bottom part 71d and the plate of the apparatus side to which the lower edge of both the side parts 71b contact. The bent plate-shaped rear part 71c is formed on the top surface side of the bottom part 71d. A height of the rear part 71c is less than the height of the side parts 71b. A height of the plate-shaped engaging member 71e is less than the height of the rear part 71c.

A latch mechanism that engages with the engaging member 71e is arranged in an inner wall surface of the banknote handling apparatus 1 at a position that corresponds to the engaging member 71e of the trash tray 71. When the trash tray 71 is inserted from the opening on the front surface of the apparatus and pushed toward the back surface side of the apparatus while sliding on the top surface of the plate arranged inside the apparatus so that the lower edge of both the side parts 71b are in contact with the top surface of the plate, the latch mechanism and the engaging member 71e engage, and, as shown in FIG. 1, the trash tray 71 is fixed in a position at which the front part 71a constitutes one surface with the front surface of the apparatus. Moreover, as shown in FIG. 1, when the trash tray 71 is further pushed toward the back surface side from the state in which the trash tray 71 has been mounted in the banknote handling apparatus 1, the engagement between the latch mechanism and the engaging member 71e is released and the trash tray 71 is pushed by the latch mechanism from the front surface of the apparatus toward the front side.

Because a rear part of a conventional trash tray was formed with a flat plate, trash and/or dust may accumulate between an outer portion of the rear part (left outer portion in FIG. 14A) and an inner wall surface of the apparatus in which the latch mechanism is provided, so that the trash tray may not be pushed inside the apparatus, and the trash tray might not be fixed to the apparatus. In the trash tray 71 according to the present embodiment, the rear part 71c is constituted by two surfaces that have an angle a of 90 degrees therebetween as shown in FIG. 14A. Therefore, a space is secured between an outer portion of the rear part 71c and an inner wall surface of the apparatus as shown with a dotted line circle in FIG. 14A. Accordingly, even if the trash is present in the outer portion of the rear part 71c, when the trash tray 71 is pushed, the trash can be pushed aside and moved in the space in the outer portion of the rear part 71c (inside the dotted line circle), and the engaging member 71e can be engaged with the latch mechanism.

As shown in FIG. 14, while the top surface of the bottom part 71d constitutes one surface from the front part 71a to the rear part 71c, the side parts 71b and the rear part 71c have different heights. Specifically, a height h2 of the rear part 71c is less than a height hl of the side parts 71b shown in FIG. 14C. Accordingly, when the trash gets accumulated and piled up in the space in the outer portion of the rear part 71c as shown with the dotted line circle in FIG. 14A, as the trash tray 71 is pushed, as shown with an arrow in FIG. 14A, the accumulated trash crosses over an upper edge of the rear part 71c and falls inside the trash tray 71.

As shown in FIG. 14, because the small space is secured between a bottom surface of the bottom part 71d and the plate on the apparatus side, when the trash gets accumulated in the space in the outer portion of the rear part 71c (particularly below the engaging member 71e), the space between the bottom surface of the bottom part 71d and the plate on the apparatus side functions as an escape space for the trash when fixing the trash tray 71 to the apparatus. Accordingly, the trash tray 71 can be pushed while preventing the trash from getting caught in the space between the trash tray 71 and the latch mechanism, and the engaging member 71e can be engaged with the latch mechanism.

In this manner, by changing the shape of the trash tray 71 from the conventional shape, even if the trash accumulates in the outer portion of the rear part 71c, it is prevented that the trash tray 71 cannot be pushed and fixed. The specific dimensions are given below as an example. In the trash tray 71 shown in FIG. 14A, a width W between inner walls of the side parts 71b is approximately 30 millimeters (mm). The height h1 from the top surface of the bottom part 71d to an upper edge of the side parts 71b shown in FIG. 14C is 13 mm. The height h2 from the top surface of the bottom part 71d to the upper edge of the rear part 71c is 6.5 mm, and a height h3 from the bottom surface of the bottom part 71d to the lower edge of the side part 71b is 3 mm.

In the present embodiment, among the four side surfaces of the apparatus, the surface on the front side of the apparatus and on which the operation/display unit 70 is arranged is referred to as the front surface, and when viewed by an operator who operates the operation/display unit 70 while being on the front side of the banknote handling apparatus 1, the side surface on the left side is referred to as a left surface, the side surface on the right side is referred to as a right surface, and a side surface of the back side of the apparatus is referred to as a back surface. Moreover, in the present embodiment, as shown in FIG. 1, a direction from the left surface to the right surface of the apparatus is taken as an X-axis direction, a direction from the front surface to the back surface of the apparatus is taken as a Y-axis direction, and a direction from the bottom surface to the top surface of the apparatus is taken as a Z-axis direction.

The banknote handling apparatus 1 includes an upper unit 11 and a lower unit 12. The hopper 20, the reject unit 50, and the operation/display unit 70 are arranged in the upper unit 11, and the banknote stacking units 30 and 40 are arranged in the lower unit 12. A recessed notch 51 that extends from the front surface to the back surface side of a housing is formed in a front bottom right of the upper unit 11. A stacking space of the reject unit 50 and a space in the notch 51 are connected. This allows confirmation of the presence/absence of a rejected banknote in the reject unit 50 and removal of the rejected banknote from the reject unit 50 to be performed easily.

The hopper 20 functions as a feed unit that feeds a banknote inside the apparatus. Specifically, the hopper 20 includes a guiding member 21 that supports the banknotes, which are placed in a stacked manner therein, from a short edge side of the banknotes (Y-axis direction). The stacked banknotes are fed one by one inside the apparatus sequentially from the bottommost banknote.

The reject unit 50 includes two stopper members 52 and a pressing member 53. The stopper members 52 stop the rejected banknote being discharged in the stacking space of the reject unit 50 from the transport path arranged inside the apparatus so that it does not jump to the outside. The pressing member 53 presses from the above the rejected banknote that has been stopped in the stacking space.

The banknote stacking units 30 and 40 each having the opening in the front surface side thereof are arranged respectively on the left and the right outer sides of the lower unit 12. The banknote fed inside the apparatus from the hopper 20 is subjected to the recognition and counting process inside the apparatus by a recognition unit. The banknote that is recognized as an object for stacking in the banknote stacking units 30 and 40 is stacked in the first banknote stacking unit 30 or the second banknote stacking unit 40 depending on a recognition result. The banknote that is not the object for stacking, the banknote that could not be recognized by the recognition unit, and the like, is stacked in the reject unit 50 as the rejected banknote.

Two stacking wheels 33 are arranged inside the banknote stacking unit 30 and two stacking wheels 43 are arranged inside the banknote stacking unit 40. These stacking wheels 33 and 43, while rotating, receive the banknotes that are transported by the transport unit inside the apparatus and discharged in the banknote stacking units 30 and 40, and stack the banknotes in an aligned manner.

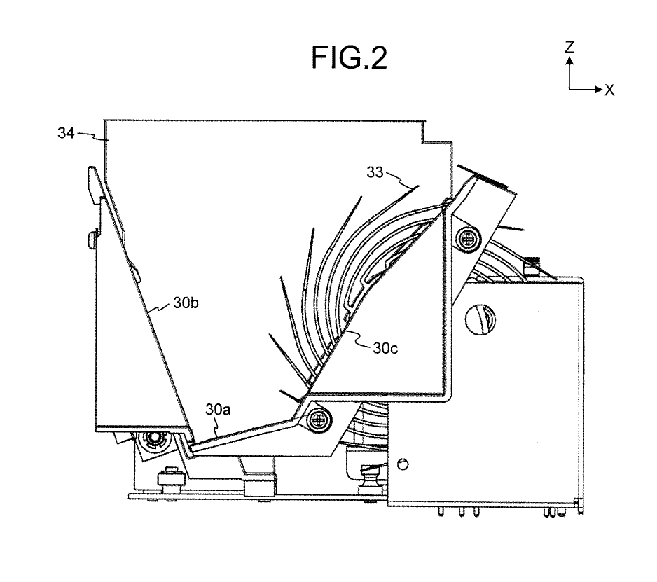

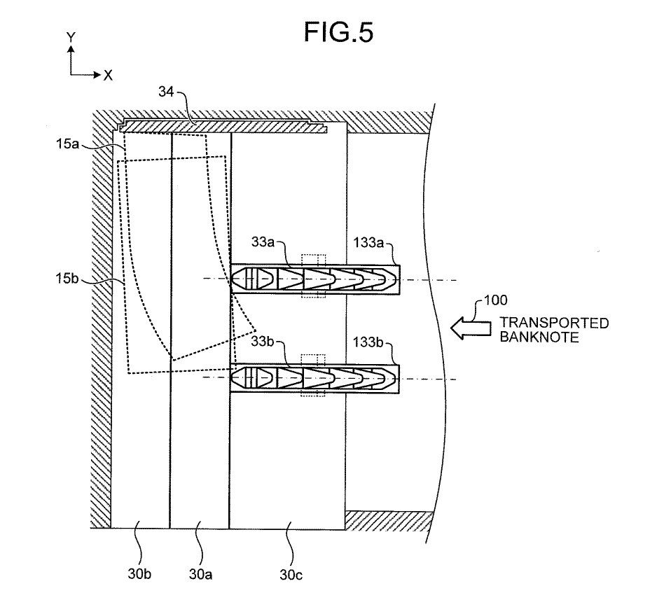

FIG. 2 is a view depicting a structure of the first banknote stacking unit 30. Inside the first banknote stacking unit 30, the two stacking wheels 33 (see stacking wheels 33a and 33b in FIG. 5) are arranged at separate positions in the Y-axis direction. The two stacking wheels 33 are coaxially fixed on one rotation axis such that positions of each of blades overlap when seen from the Y-axis direction.

In the first banknote stacking unit 30, the banknote that is transported inside the apparatus by the transport unit is discharged inside the stacking unit 30 from above a right wall 30c. The discharged banknote is sent toward a left wall 30b by the stacking wheel 33 that rotates counterclockwise around the Y axis. The left wall 30b is inclined such that the left side thereof is at a higher level than the right side thereof. The banknote sent to the left wall 30b by the stacking wheel 33 is stacked in an inclined standing state so that the inclined wall surface of the left wall 30b and the banknote face are parallel to each other. That is, the banknote is stacked in the inclined standing state such that the short edge is in the front side and the long edge is in contact with a bottom surface 30a and an upper side of the short edge is in the outer direction of the device than a lower side of the short edge.

The second banknote stacking unit 40 has the same structure as the first banknote stacking unit 30. The structure of the second banknote stacking unit 40 can be obtained by horizontally flipping the first banknote stacking unit 30 shown in FIG. 2. In the second banknote stacking unit 40, the banknote that is discharged from a left upper side is sent to a right wall inside the banknote stacking unit by the stacking wheel 43 that rotates clockwise around the Y axis. The banknote is stacked in an inclined standing state so that the banknote face is parallel to the inclined right wall whose right side is at a higher level than a left side. Though not shown in FIG. 2, the first banknote stacking unit 30 and the second banknote stacking unit 40 include a banknote detection sensor that detects a banknote stacked therein.

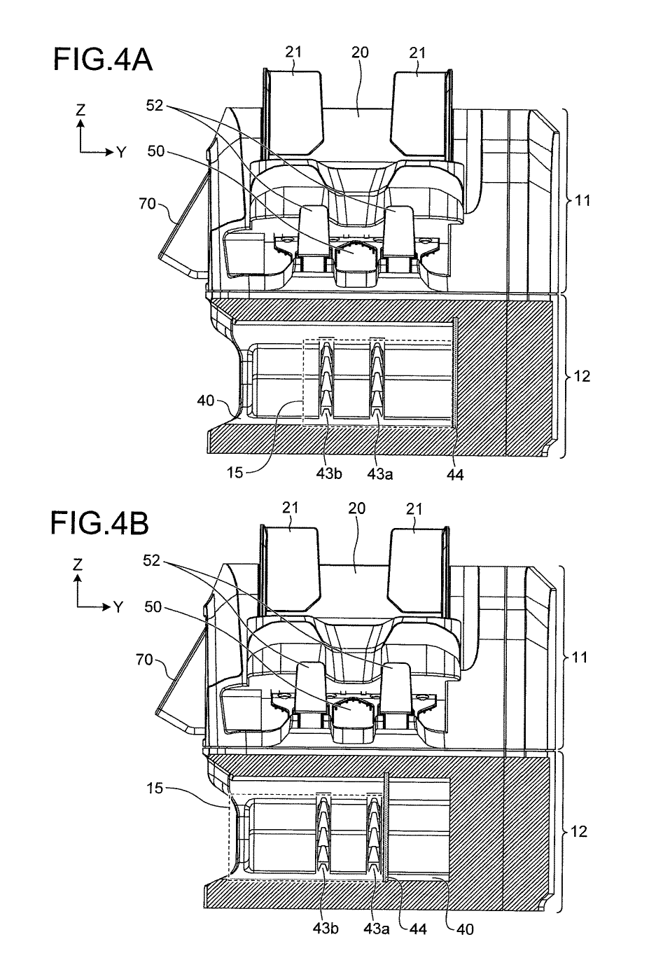

A pushing member 34 is explained below. Inside the stacking space of the first banknote stacking unit 30, the pushing member 34 is arranged on the back surface side. Similarly, inside the stacking space of the second banknote stacking unit 40, a pushing member 44 is arranged on the back surface side (see FIG. 4). In the first banknote stacking unit 30 and the second banknote stacking unit 40, all the banknotes stacked in the banknote stacking units 30 and 40 are pushed toward the respective openings by a forward movement of the respective pushing members 34 and 44. Structures of the pushing members 34 and 44 and a driving mechanism for moving the pushing members 34 and 44 are the same in both the first banknote stacking unit 30 and the second banknote stacking unit 40; therefore, these structures in the first banknote stacking unit 30 are explained below as example.

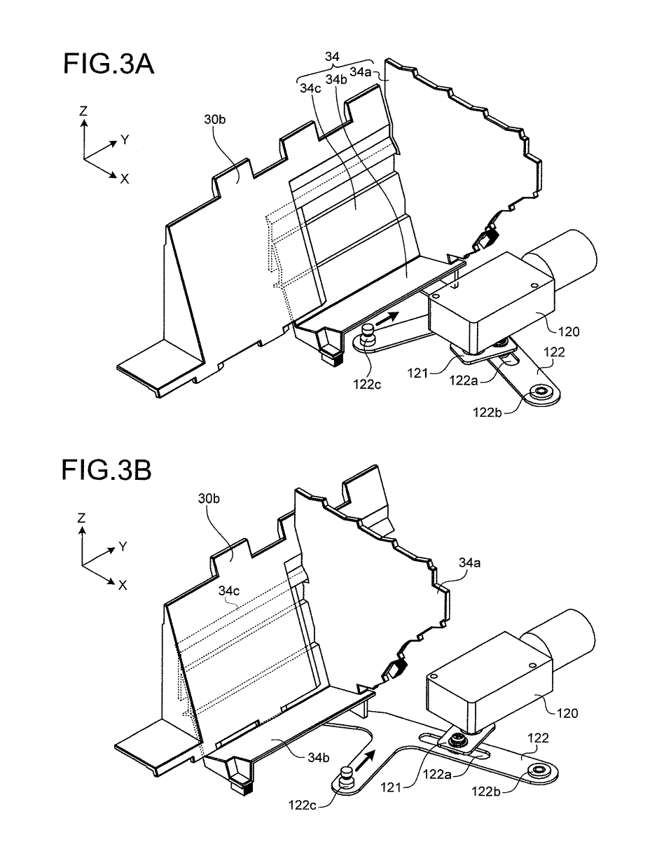

FIGS. 3A and 3B are perspective views depicting a structure of the pushing member 34 and the driving mechanism that moves the pushing member 34 that are arranged inside the first banknote stacking unit 30. In FIGS. 3A and 3B are shown the left wall 30b that is the outer wall of the apparatus (the negative X-axis direction side) on which the banknote sent by the stacking wheel 33 inside the stacking space of the first banknote stacking unit 30 is stacked such that the banknote face is in contact thereto, the pushing member 34 that is arranged so as to be slidably movable in a front-back direction (Y-axis direction) along the left wall 30b fixed to the apparatus, and the driving mechanism that drives the pushing member 34. FIG. 3A depicts a retracted position of the pushing member 34 that is the position of the pushing member 34 when the stacking of the banknote is performed. FIG. 3B depicts a pushing position that is the position of the pushing member 34 when the banknote stacked inside was pushed forward.

The pushing member 34 includes a back plate 34a, a bottom plate 34b, and a side plate 34c integrated together. The back plate 34a, the bottom plate 34b, and the side plate 34c are in the form of a thin plate. A plurality of serrated protruding members is provided on an outer peripheral edge of the back plate 34a. Recess members that engage with these protruding members are provided in the front-back direction at corresponding positions on the wall surface that constitutes the stacking space. When the pushing member 34 moves, because the protruding members of the back plate 34a move inside the recess members in the wall surface, the banknote does not enter into the space between the pushing member 34 and the wall surface. Moreover, the side plate 34c has a surface shape in which steps are formed corresponding to the protruding members of the back plate 34a. The left wall 30b is formed in a shape that matches with this surface shape of the side plate 34c. As a result, when the pushing member 34 moves, the banknote does not enter into the space between the side plate 34c and the left wall 30b.

The driving mechanism that slidingly moves the pushing member 34 in the front-back direction is constituted by a motor 120 that functions as a pushing member driving unit, a cam plate 121 rotated by the motor 120, and a linking plate 122 driven by the cam plate 121. The rotation of the cam plate 121 is converted into a front-back motion of the pushing member 34 by the linking plate 122.

The movement of the pushing member 34 in the lateral direction (X-axis direction) and the up-down direction (Z-axis direction) is suppressed and the pushing member 34 is supported so as to be slidably movable only in the front-back direction. One end of the linking plate 122 is rotatably supported by a shaft that projects from the backside of the bottom plate 34b of the pushing member 34. The other end of the linking plate 122 is rotatably supported by a rotation axis 122b fixed to the apparatus. The linking plate 122 is provided with a narrow longitudinal through-hole 122a. A shaft on one end of the cam plate 121 is inserted into this through-hole 122a while the other end of the cam plate 122a is connected to a rotation axis of the motor 120. When the cam plate 121 is rotated by the motor 120, the shaft of the cam plate 121 makes a reciprocating movement inside the through-hole 122a of the linking plate 122. Because of such a reciprocating movement, the other end of the linking plate 122 supported by the rotation axis 122b performs a back and forth movement, and the pushing member 34 connected to this other end also moves back and forth.

A not-shown sensor is arranged on the backside of the back plate 34a and this sensor detects whether the pushing member 34 has returned to the retracted position. Upon detecting that the pushing member 34 has returned to the retracted position, the rotation of the motor 120 is stopped. A not-shown spring member that applies a pulling force in the direction shown with an arrow in FIGS. 3A and 3B is attached to a shaft 122c of the linking plate 122. During the period in which the motor 120 has been stopped, the linking plate 122 moves by the pulling force of the spring member, and the pushing member 34 returns to the retracted position.

FIGS. 4A and 4B are views depicting the retracted position and the pushing position of the pushing member 44 inside the banknote stacking unit 40. FIGS. 4A and 4B depict the banknote handling apparatus 1 when viewed from the right side. FIGS. 4A and 4B depict an external appearance of the upper unit 11 whereas depict a schematic cross-section of the lower unit 12. FIG. 4A shows a state in which the pushing member 44 of the second banknote stacking unit 40 is in the retracted position, and FIG. 4B shows a state in which the pushing member 44 is in the pushing position. FIGS. 4A and 4B depict the pushing member 44 of the second banknote stacking unit 40 as an example, and the pushing member 34 of the first banknote stacking unit 30 operates in the same manner.

As shown in FIG. 4A, two stacking wheels 43a and 43b are arranged inside the second banknote stacking unit 40. A banknote 15 is fed inside the apparatus from the hopper 20, transported inside the apparatus, and then discharged in the banknote stacking unit 40. The banknote 15 is sent in a right outer side of the apparatus by the stacking wheels 43a and 43b, and is stacked in the inclined standing state as indicated with a dashed-line in FIG. 4A.

Then, as shown in FIG. 4B, the pushing member 44 moves to the pushing position that is in the back surface side of the stacking wheel 43a arranged in the back surface side. As a result, the front short edge of the stacked banknote 15 is pushed toward the opening of the second banknote stacking unit 40, and the banknote 15 can be easily removed by grasping a front edge of the banknote 15 that is in the inclined standing state. After reaching the pushing position, the pushing member 44 returns to the retracted position shown in FIG. 4A and stops there.

One technical feature of the banknote handling apparatus 1 is that, when pushing the banknotes stacked in the banknote stacking units 30 and 40 by the pushing members 34 and 44, the banknotes are pressed by a pressing member so that the banknotes being pushed are not caught in the bumps and dents or other structural component inside the apparatus.

FIG. 5 is a view depicting an internal structure of the first banknote stacking unit 30. FIG. 5 schematically shows a situation in which the first banknote stacking unit 30 is seen from above so that the opening that is present on the front side of the apparatus is on the lower side in the figure. Because the structure of the second banknote stacking unit 40 can be obtained by horizontally flipping the structure shown in FIG. 5, the explanation about the second banknote stacking unit 40 is omitted, and only the first banknote stacking unit 30 will be explained.

Openings 133a and 133b are formed in the right wall 30c that constitutes the stacking space in the first banknote stacking unit 30. As shown in FIG. 2, a part of the stacking wheels 33a and 33b is exposed inside the stacking space from the respective openings 133a and 133b.

The banknote transported on the transport path is discharged inside the banknote stacking unit from the right side as shown with an arrow 100 in FIG. 5. The discharged banknote is received between the blades of the two stacking wheels 33a and 33b, and sent toward the left wall 30b and stacked. In doing so, as shown with a dotted line in FIG. 5, it is possible that the stacked banknotes contain a banknote 15a stacked in a folded manner, and/or a banknote 15b stacked but caught in the opening 133b. If the pushing of the stacked banknotes is performed by the pushing member 34 in this state, the banknotes 15a and/or 15b may be caught in the opening 133b and/or the stacking wheel 33b, and may not be pushed as desired. To avoid this, in the banknote handling apparatus 1, the stacking wheels 33a and 33b are used as a pressing member when performing the pushing of the banknote by the pushing member 34.

Specifically, by rotating the stacking wheels 33a and 33b counterclockwise around the Y axis (from right to left in FIG. 5) in the same manner as done when stacking the banknote, a pressing force that presses the stacked banknotes toward the left wall 30b is applied to the banknotes 15a and 15b. While applying the pressing force, the pushing of the banknotes is performed by the pushing member 34. By rotation of the stacking wheels 33a and 33b, the banknotes 15a and 15b are pushed away from the stacking wheels 33a and 33b and the openings 133a and 133b. All the stacked banknotes can be surely pushed toward the opening of the stacking unit by performing the pushing of the banknotes by the pushing member 34 while rotating the stacking wheels 33a and 33b.

In the banknote handling apparatus 1, a rotational speed and a rotation direction of the stacking wheels 33 and 43 can be controlled as desired. Specifically, a rotational speed of the stacking wheels 33 and 43 when pushing the banknote by the pushing members 34 and 44 and a rotational speed of the stacking wheels 33 and 43 when stacking the banknote that has been transported by the transport unit inside the apparatus can be set same, or can be set different. Also, a rotation direction of the stacking wheels 33 and 43 when pushing the banknote by the pushing members 34 and 44 and a rotation direction of the stacking wheels 33 and 43 when stacking the banknote that has been transported by the transport unit inside the apparatus can be set same, or can be set different.

For example, the stacking wheels 33 and 43 are rotated at a high speed when stacking the banknote to perform banknote handling faster, and when using the stacking wheels 33 and 43 as the pressing member that presses the banknote being pushed by the pushing members 34 and 44, the rotational speed is reduced to rotate the stacking wheels 33 and 43 at a low speed.

When using the stacking wheels 33a and 43a as the pressing member, the stacking wheels 33 and 43 can be rotated at a constant rotational speed or they can be rotated while changing the rotational speed. Moreover, when performing the pushing of the banknote by the pushing member 34, the stacking wheels 33 and 43 can be rotated continuously, or they can be rotated intermittently by repeating rotation and stopping. Moreover, with respect to the rotation direction, the rotation can always be in one direction, clockwise or counterclockwise, or the rotation direction can be changed in between.

For example, in the first banknote stacking unit 30, after the stacking wheel 33 is rotated clockwise only for a first predetermined duration or a predetermined number of rotations so that the banknote 15b being caught in the opening 133b is pushed and separated from the opening 133b, the rotation direction of the stacking wheel 33 is changed, and the stacking wheel 33 is rotated counterclockwise thereby pushing the banknote 15b toward the left wall 30b. Moreover, for example, the rotation direction of the stacking wheels 33 and 43 is switched intermittently between clockwise and counterclockwise thereby shaking the stacking wheels 33 and 43.

When pushing the banknote, how the stacking wheels 33 and 43 are to be rotated can be set previously. An answer to which method of rotating the stacking wheels 33 and 43 for pressing the banknote is effective for surely pushing the banknote by the pushing members 34 and 44 can vary depending on the structures of and/or the positional relation between the banknote stacking units 30 and 40 and the respective stacking wheels 33 and 43, a size, a paper quality, and the like of the banknotes that are to be stacked in the banknote stacking units 30 and 40. The rotation method of the stacking wheels 33 and 43, including the rotational speed and the rotation direction, can be set after considering these factors.

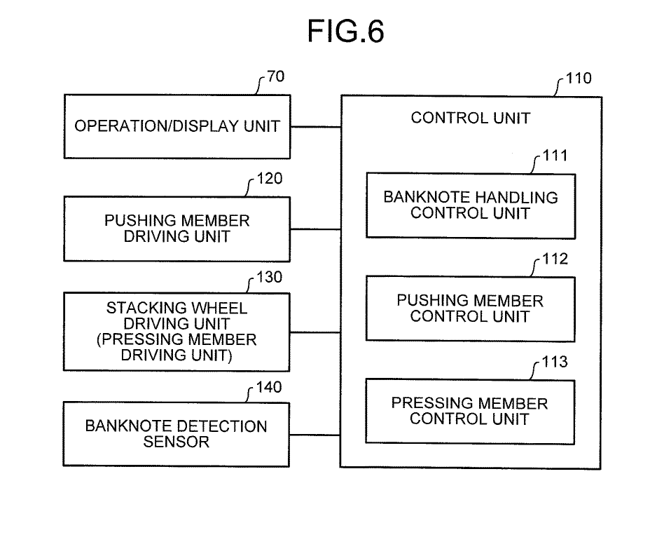

FIG. 6 is a block diagram of a functional unit that controls operations of the stacking wheels 33 and 43 that function as the pressing member and operations of the pushing members 34 and 44. Though the banknote handling apparatus 1 has a function to perform various banknote handling, only those functional units that are necessary for the explanation of the present embodiment are shown in FIG. 6.

The banknote handling apparatus 1 includes the operation/display unit 70, a control unit 110, a pushing member driving unit 120, a stacking wheel driving unit (pressing member driving unit) 130, and a banknote detection sensor 140. The operation/display unit 70 is a touch-panel type liquid crystal display and can be used to input information and/or to give orders and/or instructions and the like relating to the banknote handling. A result of recognition and counting and the like of the banknote and various information relating to the banknote handling can be displayed on the operation/display unit 70. The pushing member driving unit 120 has a function to drive the pushing members 34 and 44 to push the banknotes inside the banknote stacking units 30 and 40. The motor 120 shown in FIG. 3 functions as the pushing member driving unit 120 that slidingly moves the pushing members 34 and 44 between the retracted position and the pushing position. The banknote detection sensor 140 is a sensor that detects presence/absence of a stacked banknote in the banknote stacking units 30 and 40.

The stacking wheel driving unit 130 has a function to drive the stacking wheels 33 and 43 when pushing the banknote by the pushing members 34 and 44. The stacking wheel driving unit 130 functions as the pressing member driving unit that drives the stacking wheels 33 and 43 that function as the pressing member that presses the banknote.

The control unit 110 includes a banknote handling control unit 111, a pushing member control unit 112, and a pressing member control unit 113. The banknote handling control unit 111 has a function to perform banknote handling. In the banknote handling, the banknotes set in the hopper 20 are fed, one by one, into inside the apparatus, the recognition unit performs the recognition and counting of the banknotes transported by the transport unit on the transport path, and the banknote is stacked in either the banknote stacking units 30 and 40 or the reject unit 50 based on the obtained recognition result.

Apart from an operation mode in which the processing is continued until all the banknotes set in the hopper 20 are stacked in either the banknote stacking units 30 and 40 and the reject unit 50, the banknote handling apparatus 1 can perform a batch processing in which a predetermined number of stacked banknotes are removed from the banknote stacking units 30 and 40 each time the number of banknotes being stacked in the banknote stacking units 30 and 40 reaches the predetermined number. In the batch processing, stacking of the banknotes in the banknote stacking units 30 and 40 is stopped when the number of banknotes stacked in the banknote stacking units 30 and 40 reaches the predetermined number. Subsequently, when it is detected by the banknote detection sensor 140 that the stacked banknotes of the predetermined number had been removed via the front opening, the stacking of the banknote is started again. This process is repeated until all the banknotes set in the hopper 20 are processed.

The pushing member control unit 112 has a function for controlling the operation of pushing the banknote by the pushing members 34 and 44 by controlling the pushing member driving unit 120. The pressing member control unit 113 has a function for controlling the operation of pressing by the stacking wheels 33 and 43, which function as the pressing member, by controlling the stacking wheel driving unit 130 that functions as the pressing member driving unit. The method of rotation of the stacking wheels 33 and 43 that press the banknote is set previously. Accordingly, the pressing member control unit 113 controls the stacking wheel driving unit 130 based on this setting contents.

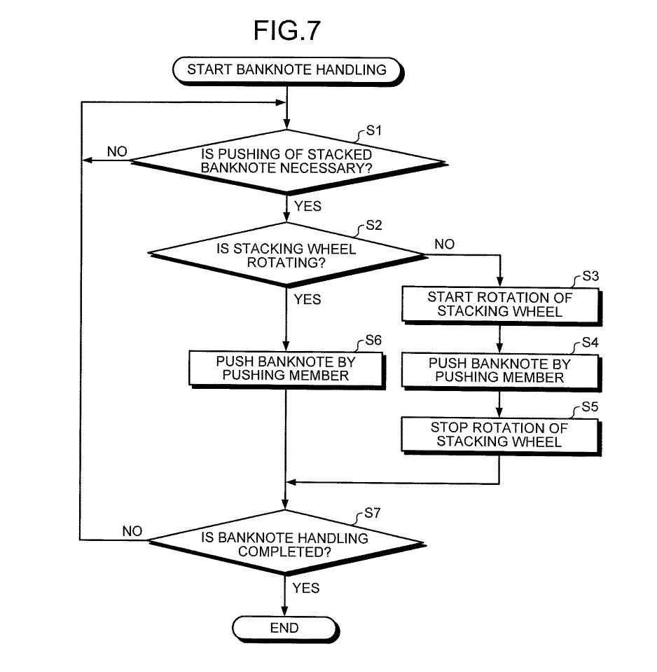

FIG. 7 is a flowchart depicting a flow of a process procedure for pushing a banknote present inside the banknote stacking units 30 and 40 by the pushing members 34 and 44 while controlling the rotation of the stacking wheels 33 and 43. After the banknote handling is started by the banknote handling control unit 111, the pushing members 34 and 44 are in a standby state at the retracted position in the back surface side inside the stacking unit 30 and 40 until it becomes necessary to push the banknotes stacked in the banknote stacking units 30 and 40 (Step S1: No).

For example, after all the banknotes set in the hopper 20 are stacked in either the banknote stacking units 30 and 40 or the reject unit 50, a user of the banknote handling apparatus 1 checks the result of banknote handling displayed on the operation/display unit 70 and performs an operation to confirm this process.

Alternatively, for example, after all the banknotes set in the hopper 20 are fed inside the apparatus and stacked in either the banknote stacking units 30 and 40 or the reject unit 50, if the operation to confirm is not performed by the user while a predetermined time period set previously, the process can be confirmed automatically.

Alternatively, for example, if the banknotes set in the hopper 20 contain a predetermined paper sheet called a separator card, the process can be confirmed automatically when the recognition unit detects such a separator card. The separator card is a paper sheet that can be inserted between the banknotes of different transactions to distinguish the banknotes of each of the transactions when placing the banknotes of different transactions in a lump on the hopper 20 and processing the banknotes. For example, a predetermined design, such as a barcode, a predetermined character, and the like is typically printed on the surface of the separator card. The banknotes set in the hopper 20 are fed one by one inside the apparatus and subjected to the recognition and counting process by the recognition unit. When the recognition unit detects the separator card based on the predetermined design, character, and the like printed thereon, the banknote handling control unit 111 recognizes that the banknotes processed before the detection of the separator card and the banknotes processed after the detection of the separator card belong to the different transaction, and stops the banknote handling. Subsequently, the banknote handling control unit 111 confirms the transaction before the detection of the separator card.

A banknote can be used to distinguish the banknotes of each transaction when the banknotes of a plurality of transactions are set in the hopper 20, apart from using the separator card. For example, the banknote handling apparatus 1 can previously acquire serial numbers of banknotes that are at the boundaries of the transactions, and distinguish the banknotes of each of the transactions based on those serial numbers. The banknote at the boundary can be the last banknote of the current transaction or can be the first banknote of a subsequent transaction. Specifically, based on the serial number read from each banknote, when the last banknote of the current transaction is detected, the current transaction is confirmed after stacking the detected last banknote in the banknote stacking units 30 and 40. Alternatively, based on the serial number read from each banknote, when the first banknote of the subsequent transaction to be performed after the current transaction is detected, the current transaction is confirmed after stacking the last banknote, which has been transported before the detected first banknote, in the banknote stacking units 30 and 40.

When the banknote handling is confirmed in this manner, the banknote handling control unit 111 notifies the pushing member control unit 112 and the pressing member control unit 113 that the banknote handling has been confirmed. The pushing member control unit 112 and the pressing member control unit 113, upon receiving such a notification, determine that the pushing of the banknotes stacked in the banknote stacking units 30 and 40 is necessary (Step S1: Yes).

If the banknote handling has been confirmed and the rotation of the stacking wheels 33 and 43 has been already stopped (Step S2: No), the pressing member control unit 113 controls the stacking wheel driving unit 130 to start the rotation of the stacking wheels 33 and 43 (Step S3). After the stacking wheels 33 and 43 have started rotation, the pushing member control unit 112 controls the pushing member driving unit 120 to start pushing of the stacked banknotes by the pushing members 34 and 44 (Step S4). Inside the respective banknote stacking units 30 and 40, when the pushing members 34 and 44 move from the retracted position toward the front opening to push the stacked banknotes and reach the pushing position, the pressing member control unit 113 that recognizes this fact controls the stacking wheel driving unit 130 to stop rotation of the stacking wheels 33 and 43 (Step S5). The pushing members 34 and 44 are continued to be driven by the pushing member driving unit 120 even after they have reached the pushing position, and are moved to the retracted position and stopped. It is allowable to arrange a sensor that detects whether the pushing members 34 and 44 have reached the pushing position. Alternatively, the same can be determined based on the rotation of the motor 120 that functions as the pushing member driving unit and the like.

After the stacking wheels 33 and 43 have stopped rotation, the user of the banknote handling apparatus 1 can remove the banknotes, which have been pushed toward the opening, from the banknote stacking units 30 and 40. After having pushed all the banknotes toward the opening, if the banknote handling has been completed because no banknote is remaining in the hopper 20 (Step S7: Yes), the process procedure is finished. Meanwhile, when the transaction was confirmed by detecting the separator card and the handling target banknotes are remaining in the hopper 20 (Step S7: No), the banknote handling control unit 111 starts the subsequent banknote handling after the banknote detection sensor 140 has detected that the banknotes of the confirmed transaction had been removed via the opening of the banknote stacking units 30 and 40 (Step S1).

The stacking wheels 33 and 43 start rotating before the pushing members 34 and 44 start the pushing. The stacking wheels 33 and 43 stop rotating after completion of the pushing by the pushing members 34 and 44. That is, the stacking wheels 33 and 43 rotate while the pushing members 34 and 44 are moving from the retracted position to the pushing position. However, the rotation start and rotation stop timings of the stacking wheels 33 and 43 can be set as desired. For example, it is allowable to set so that the stacking wheels 33 and 43 start rotating after the pushing members 34 and 44 have started their movement. Moreover, for example, it is allowable to set so that the stacking wheels 33 and 43 stop rotating before the pushing members 34 and 44 have reached the pushing position. Alternatively, it is allowable to set so that the stacking wheels 33 and 43 continue rotating until the pushing members 34 and 44 have returned to the retracted position after moving to the pushing position. The timing of starting and stopping the rotation of the stacking wheels 33 and 43 can be set previously, based on the structures of and/or the positional relation between the banknote stacking units 30 and 40 and the respective stacking wheels 33 and 43, a size, a paper quality, and the like of the banknotes that are to be stacked in the banknote stacking units 30 and 40, so that the pushing of the banknotes can be performed surely.

When the banknote handling performed by the banknote handling apparatus 1 is the batch processing, the stacking of banknotes is stopped because the previously set predetermined number of banknotes have been stacked in the banknote stacking units 30 and 40. The banknote handling control unit 111 notifies the pushing member control unit 112 and the pressing member control unit 113 of this fact. The pushing member control unit 112 and the pressing member control unit 113, upon receiving such a notification, determine that the pushing of the banknotes stacked in the banknote stacking units 30 and 40 is necessary (Step S1: Yes).

If the handling target banknotes are still remaining on the hopper 20 and the stacking wheels 33 and 43 are rotating (Step S2: Yes), the pushing member control unit 112 controls the pushing member driving unit 120 so that the pushing members 34 and 44 perform the pushing (Step S6). While the stacking wheels 33 and 43 continue rotation, the pushing members 34 and 44 move from the retracted position to the pushing position. The banknotes stacked in the stacking units 30 and 40 are pushed toward the opening by the pushing members 34 and 44. While the stacking wheels 33 and 43 still continue rotation, the pushing member 34 and 44 return to the retracted position again and stop. Because the banknotes are still remaining in the hopper 20 (Step S7: No), if the pushed banknotes are removed from the opening of the banknote stacking units 30 and 40, the banknote handling control unit 111 detects the removal of banknotes by the banknote detection sensor 140. Accordingly, the banknote handling control unit 111 restarts stacking of the banknote in the banknote stacking units 30 and 40 from which the banknotes were removed (Step S1).

Meanwhile, even when the batch processing is being performed, there is a case in which handling of all the banknotes set in the hopper 20 has been completed, all the banknotes have been stacked in either the banknote stacking units 30 and 40 and the reject unit 50, and the pushing of the banknotes is to be performed (Step S1: Yes). In this case, the rotation of the stacking wheels 33 and 43 had been stopped (Step S2: No) because all the banknotes have been already stacked in either the banknote stacking units 30 and 40 and the reject unit 50, Steps S3 to S5 are executed. When the pushing members 34 and 44 return to the retracted position after finishing the pushing of the banknotes, the batch processing had been already completed (Step S7: Yes). Therefore, the process procedure is completed.

Like in the batch processing, when performing the pushing of the banknotes by the pushing members 34 and 44 in the middle of the banknote handling, the rotation motion of the stacking wheels 33 and 43, which are rotating to perform the banknote handling, is maintained. While the stacking wheels 33 and 43 keep rotating, the pushing process by the pushing members 34 and 44 is performed. It should be noted that, the rotational speed and the rotation direction of the stacking wheels 33 and 43 during the pushing process can be set different from the rotational speed and the rotation direction thereof during the banknote handling.

When performing the pushing of the stacked banknotes in the middle of the batch processing, the pushing of the stacked banknotes is performed only in the banknote stacking unit between the banknote stacking units 30 and 40, in which the stacking of the banknote has been stopped and it has become necessary to perform the pushing of the stacked banknotes of the predetermined number. The banknote handling is just continued in the banknote stacking unit between the banknote stacking units 30 and 40, in which the stacking of the banknotes is being performed.

The first banknote stacking unit 30 includes one pushing member 34, the pushing member driving unit 120, and one stacking wheel 33 that function as the pressing member, and the stacking wheel driving unit 130. Separately from the first banknote stacking unit 30, the second banknote stacking unit 40 includes one pushing member 44, the pushing member driving unit 120, and one stacking wheel 43 that function as the pressing member, and the stacking wheel driving unit 130. The transport unit that transports the banknotes on the transport path inside the apparatus during the banknote handling, the pushing member driving unit 120, and the stacking wheel driving unit 130, are arranged separately. That is, transport of the banknote by a driving mechanism (first driving mechanism) that includes the transport unit, the movement of each of the pushing members 34 and 44 by the driving mechanism (second driving mechanism) that includes the pushing member driving unit 120, and the rotation of each of the stacking wheels 33 and 43 by a driving mechanism (third driving mechanism) that includes the stacking wheel driving unit 130 can be performed independently.

Specifically, for example, while the stacking wheel 33 is rotating and the banknotes are being stacked in the first banknote stacking unit 30, stacking of the banknote can be stopped in the second banknote stacking unit 40. At this time, it is also possible to stop the pushing member 34 and the stacking wheel 43 of the second banknote stacking unit 40. Alternatively, it is possible to move only the pushing member 34, to rotate only the stacking wheel 43, to move the pushing member 34 while rotating the stacking wheel 43, and the like.

The stacking wheels 33 and 43 are used to stack the banknotes during the banknote handling. Additionally, when pushing the banknotes by the pushing members 34 and 44, the stacking wheels 33 and 43 are used as the pressing member that presses the banknotes that are being pushed by the pushing members 34 and 44. A structure is allowable in which a patting member is arranged in a portion where the stacking wheels 33 and 43 contact the banknote.

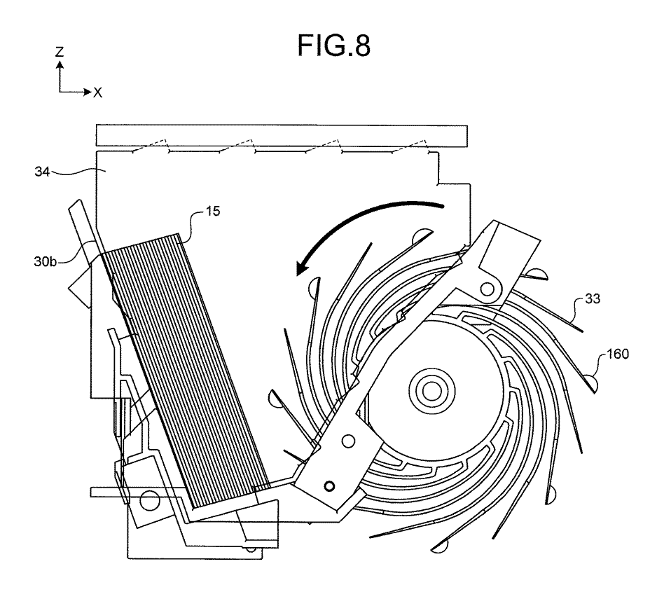

FIG. 8 is a view depicting an example of the stacking wheel 33 provided with a patting member 160. FIG. 8 is a view when the first banknote stacking unit 30 is seen from the front surface side. Note that, the stacking wheel 33 of the first banknote stacking unit 30 is shown in FIG. 8, and the stacking wheel 43 of the second banknote stacking unit 40 has the same structure.

As shown in FIG. 8, the patting member 160 that pats the banknote is arranged at far tip ends in a diameter direction of the blades of the stacking wheel 33. In the example shown in FIG. 8, the stacking wheel 33 has 16 blades, and 8 patting members 160 in total, one each for alternate blades, are arranged; however, the number of the patting members 160 is not particularly limited. The patting member 160 can be formed, for example, integrally with the blade, which is made of resin, of the stacking wheel 33. Alternatively, the patting member 160, which is made from resin or rubber, can be attached to each of the blades of the stacking wheel 33.

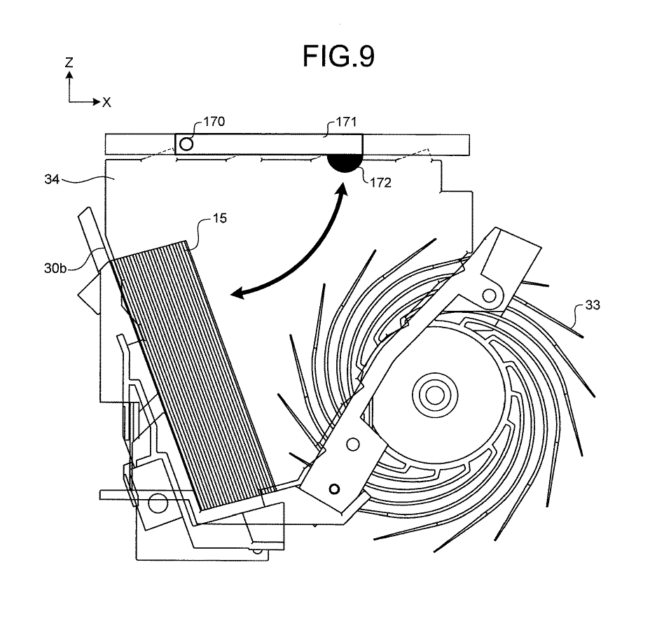

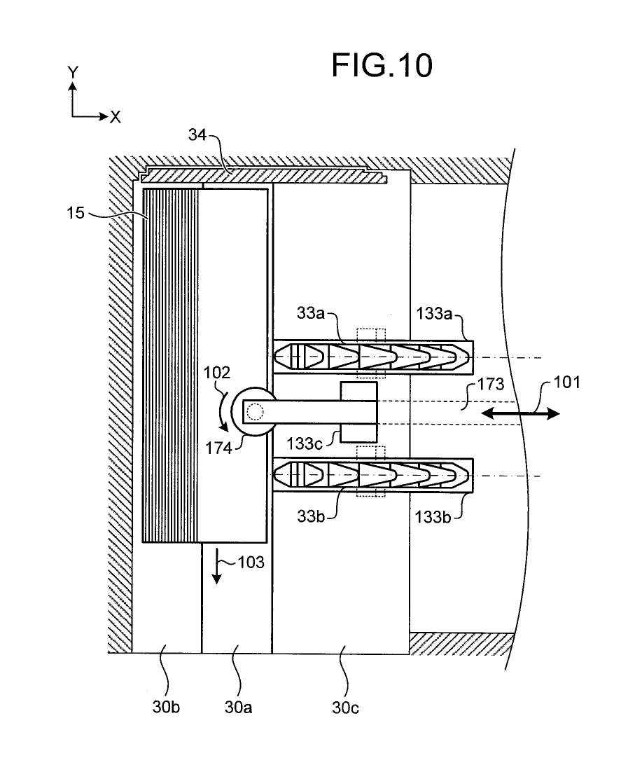

It is allowable to provide, inside the banknote stacking units 30 and 40, the pressing member separately from the stacking wheels 33 and 43. FIGS. 9 to 12 are views depicting examples of the pressing member provided separately from the stacking wheels 33 and 43. FIG. 9 is a view when the first banknote stacking unit 30 is seen from the front surface side. FIGS. 10 to 12 are views when the first banknote stacking unit 30 is seen from above. Note that, only the first banknote stacking unit 30 is shown in FIGS. 9 to 12; however, the second banknote stacking unit 40 also includes the similar pressing member.

FIG. 9 is a view depicting an example of a pressing member arranged pivotably on a roof surface of the stacking unit. In the example shown in FIG. 9, a pressing member 171 is arranged on the roof surface of the stacking space in which the banknotes are stacked, and the pressing member 171 is supported so as to be pivotable in the manner shown with an arrow by a support shaft 170 at a position that is in between the two stacking wheels 33 (33a, 33b) arranged at different locations along the Y-axis direction. A tip end part 172 of the pressing member 171 is constituted by an elastic member such as rubber. The pressing member 171 is pivotable, by the not-shown pressing member driving unit 130, between a retracted position shown in FIG. 9 and a pressing position in which the pressing member 171 pivots on the support shaft 170 so that the tip end part 172 contacts the banknotes 15 and presses the banknotes 15. When pushing the banknotes 15 with the pushing member 34 toward the opening, the pressing member control unit 113 controls the pressing member driving unit 130 to cause the pressing member 171 to pivot to the pressing position and press the banknotes 15 toward the left wall 30b. Once the pushing by the pushing member 34 is finished, the pressing member 171 is caused to return to the retracted position and wait.

FIG. 10 is a view depicting an example of a pressing member arranged retractably in an opening 133c arranged in a side surface of the stacking unit. In the example shown in FIG. 10, a pressing member 173 retractable as shown with an arrow 101 is arranged in the opening 133c of the right wall 30c that constitutes the stacking space. A roller 174 is rotatably attached to a tip of the pressing member 173. The roller 174 is supported such that it rotates in a direction shown with an arrow 102 following the movement of the banknotes 15 when the banknotes 15 pushed by the pushing member 34 move in a direction shown with an arrow 103. Accordingly, the banknotes 15 move smoothly as the banknotes 15 being pushed create no resistance against the pushing even while the banknotes 15 are being pressed toward the left wall 30b by the pressing member 173. The not-shown pressing member driving unit 130 moves the pressing member 173 between a pushing position shown in FIG. 10 and a retracted position which is a position right side of the opening 133c, that is, outside of the stacking space (right side of the right wall 30c). When pushing the banknotes 15 with the pushing member 34 toward the opening, the pressing member control unit 113 controls the pressing member driving unit 130 to cause the pressing member 173 to move to the pressing position and press the banknotes 15 toward the left wall 30b. Once the pushing by the pushing member 34 is finished, the pressing member 173 is caused to return to the retracted position and wait.

It is allowable that the tip end part 172 of the pressing member 171 shown in FIG. 9 is replaced with a roller, like in FIG. 10, that is supported rotatably to rotate in the direction of pushing of the banknotes 15. Alternatively, the roller 174 arranged at the tip of the pressing member 173 shown in FIG. 10 can be replaced with an elastic member like in FIG. 9. The configuration to prevent generation of the resistance against the pushing on the pushed banknote 15 is not limited to the roller 174. It is allowable to use a ball and the like that can rotate freely.

The number of the pressing members 171 and 173 is not limited to one, and these members can be provided in plurality. For example, the pressing member 171 shown in FIG. 9 can be provided in plurality at positions that are separated in the Y-axis direction. Moreover, when such pressing members 171 are provided, lengths thereof from the support shaft 170 to the tip end part 172 can be varied thereby changing the pressing position of the banknotes 15 in the Z-axis direction. Similarly, for example, the pressing member 173 shown in FIG. 10 can be provided in plurality at positions that are separated in the Y-axis direction. Alternatively, the pressing member 173 can be provided in plurality at positions that are separated in the Z-axis direction.

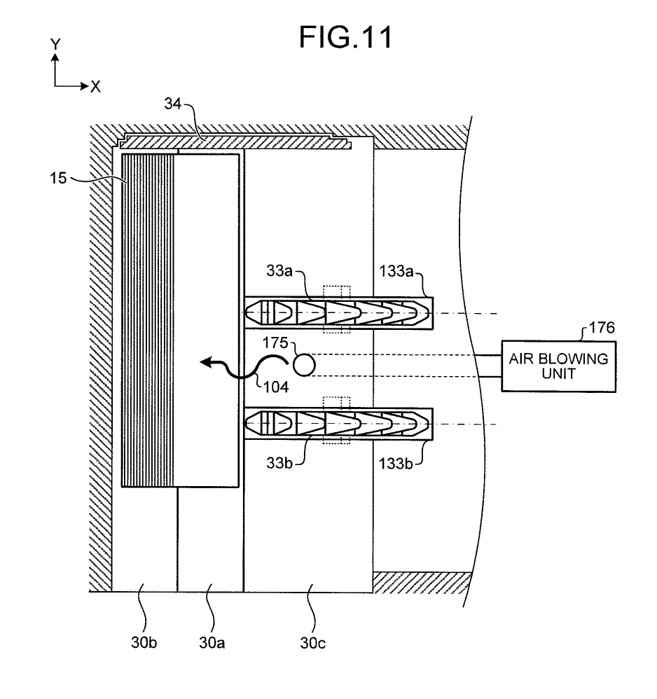

FIG. 11 is a view depicting an example of a pressing member that presses the banknotes 15 by wind pressure. The pressing member shown in FIG. 11 includes an air outlet 175 formed in the right wall 30c that constitutes the stacking space, and an air blowing unit 176 that blows air from the air outlet 175 to apply a wind pressure on the banknotes 15 as shown with an arrow 104. The air blowing unit 176 and the air outlet 175 are connected to each other with a hard pipe, a flexibility tube, and the like so that the air fed from the air blowing unit 176 is blown from the air outlet 175. When pushing the banknotes 15 toward the opening with the pushing member 34, the pressing member control unit 113 controls the air blowing unit 176 to blow air from the air outlet 175 and apply wind pressure on the banknotes 15 thereby pressing the banknotes 15 toward the left wall 30b. Once the pushing by the pushing member 34 is finished, the operation of the air blowing unit 176 is stopped. The shape and the number of the air outlets 175 shown in FIG. 11 are exemplary and need not be limited to this example. For example, a circular air outlet can be provided in plurality. Alternatively, the air outlet can be a narrow slit that extends in the X-axis direction of FIG. 11.

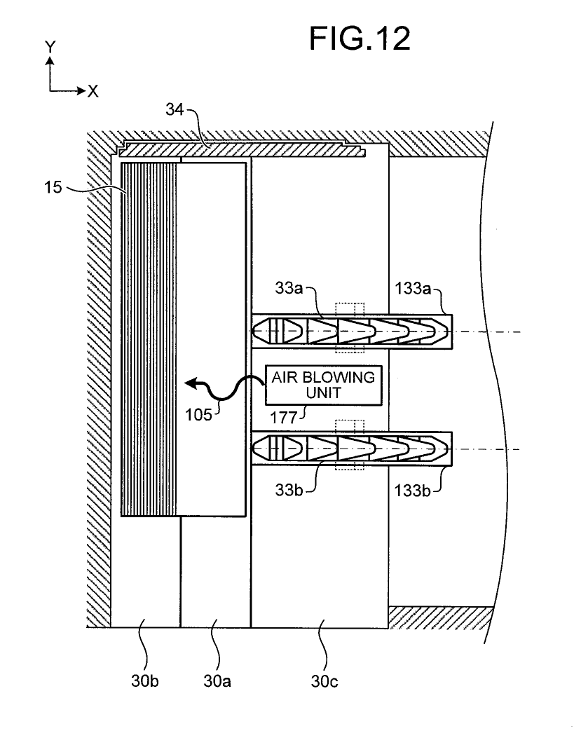

FIG. 12 is a view depicting another example of a pressing member that presses the banknotes 15 by wind pressure. The pressing member shown in FIG. 12 includes an air blowing unit 177 arranged on the right wall 30c that constitutes the stacking space. The air blowing unit 177 blows air as shown with an arrow 105. When pushing the banknotes 15 toward the opening with the pushing member 34, the pressing member control unit 113 controls the air blowing unit 177 to blow the air and apply wind pressure on the banknotes 15 thereby pressing the banknotes 15 toward the left wall 30b. Once the pushing by the pushing member 34 is finished, the operation of the air blowing unit 177 is stopped.

The present embodiment explained an example in which the two banknote stacking units 30 and 40 respectively included the two stacking wheels 33 and 43; however, the number of the banknote stacking units 30 and 40 and the number of the stacking wheels 33 and 43 are not particularly limited. Instead of the stacking wheels and 43, it is allowable to use a rotating member used conventionally and called an elastic fin wheel as the pressing member. Specifically, a rotating member that includes a shaft member supported and rotationally driven by a rotation axis and an arm member that extends in a diameter direction of the shaft member can be used as a pressing member that presses the banknotes by the arm member while rotating in the manner as the stacking wheels 33 and 43. The number of the arm members is not particularly limited. It is allowable to arrange the patting member 160 shown in FIG. 8 at a far tip end in a diameter direction of the arm member.

An example has been explained in which, when the control unit 110 recognizes that it has become necessary to perform the pushing of the banknote in the banknote stacking units 30 and 40, the pushing by the pushing members 34 and 44 and the pressing by the stacking wheels 33 and 43 that function as the pressing member is performed automatically; however, the configuration is not limited to the present embodiment. For example, it is allowable that the pushing and the pressing of the banknotes is performed when the user of the banknote handling apparatus 1 performs an operation with the operation/display unit 70 to instruct the pushing of the banknotes.

It is allowable to perform the pressing of the banknotes only when it is determined from the stacking state of the banknotes inside the banknote stacking units 30 and 40 that it is necessary to perform the pressing of the banknotes in the banknote stacking units 30 and 40. Specifically, the banknote detection sensor 140 that detects the banknotes present inside the banknote stacking units 30 and 40 is further arranged so as to be able to detect the banknotes 15a and 15b shown in FIG. 5 that are in a bad stacking state and therefore need to be pressed when being pushed. Before starting the pushing of the banknotes in the banknote stacking units 30 and 40, the pressing member control unit 113 causes the banknote detection sensor 140 to detect the stacking state of the banknotes and determines whether it is necessary to perform the pressing of the banknotes. Upon determining that it is necessary to perform the pressing of the banknotes because there are banknotes in the bad stacking state, the pressing member driving unit 130 is controlled to press the banknotes 15a and 15b. Meanwhile, if the banknotes have been stacked in an aligned state whereby it is determined that it is not necessary to press the banknotes, the banknotes are not pressed.

Instead of a configuration in which the banknotes are always pressed, or a configuration in which the banknotes are pressed only when it is necessary to press the banknotes when the pushing of the banknotes is performed, it is allowable to have a configuration in which it is possible to turn off the pressing function so that the banknotes are not pressed. In this case, for example, if the banknote handling apparatus 1 is going to be used for handling only new banknotes, it is possible to turn off the pressing function beforehand.

With the paper sheet handling apparatus according to the present embodiment, inside the banknote stacking units 30 and 40, the banknotes pushed by the pushing members 34 and 44 can be pressed by the pressing members in a direction that is orthogonal to the direction of pushing of the banknotes. For example, when the banknote is stacked in the manner in which the banknote face is parallel to the wall surface that constitutes the stacking space, the banknote is pressed so that the banknote face complies with the wall surface.

For example, the stacking wheels 33 and 43 that are used for stacking the banknotes in the banknote stacking units 30 and 40 can be used as the pressing member and the banknotes can be pressed in a direction going away from the stacking wheels 33 and 43. Accordingly, the pushed banknotes will not be caught in the stacking wheels 33 and 43 and/or the openings and the like formed in the wall surfaces on which the stacking wheels 33 and 43 are arranged whereby the banknotes can be pushed surely. Moreover, because the rotation method of the stacking wheels 33 and 43, including the rotational speed and the rotation direction, can be set as desired, by setting the rotation method of the stacking wheels 33 and 43 based on the structures of and/or the positional relation between the banknote stacking units 30 and 40 and the respective stacking wheels 33 and 43, a size, a paper quality, and the like of the banknotes that are to be stacked, the banknotes can be surely pushed toward the opening while pressing them.

### INDUSTRIAL APPLICABILITY

As explained above, the paper sheet handling apparatus according to the present invention is useful in surely pushing with the pushing member the banknote stacked in the banknote stacking unit.

### EXPLANATION OF REFERENCE NUMERALS

1 Banknote handling apparatus

11 Upper unit

12 Lower unit

20 Hopper

21 Guiding member

30, 40 Banknote stacking unit

33 (33a, 33b), 43 (43a, 43b) Stacking wheel

34, 44 Pushing member

50 Reject unit

52 Stopper member

53 Pressing member

70 Operation/display unit

71 Trash tray

110 Control unit

111 Banknote handling control unit

112 Pushing member control unit

113 Pressing member control unit

120 Motor (pushing member driving unit)

121 Cam plate

122 Linking plate

130 Stacking wheel driving unit (pressing member driving unit)

140 Banknote detection sensor

160 Patting unit

171, 173 Pressing member

174 Roller

176, 177 Air blowing unit

1. A paper sheet handling apparatus comprising:
a feed unit that feeds a paper sheet;
a transport unit that transports the paper sheet fed by the feed unit;
a stacking unit that stacks therein the paper sheet transported by the transport unit and has an opening for removing the paper sheet stacked therein;
a pushing member that pushes the paper sheet present in the stacking unit toward the opening;
a pressing member that presses the paper sheet pushed by the pushing member; and
a control unit that controls driving the pressing member based on an operation of the pushing member.

2. The paper sheet handling apparatus as claimed in claim 1, wherein, while the pushing member is pushing the paper sheet, the pressing member presses the paper sheet in a direction that is orthogonal to a pushing direction of the pushing member.

3. The paper sheet handling apparatus as claimed in claim 1, wherein the pressing member is a rotating member that is used for stacking the paper sheet inside the stacking unit, and the rotating member presses the paper sheet while rotating.

4. The paper sheet handling apparatus as claimed in claim 3, wherein
the rotating member is a stacking wheel, and
when stacking the paper sheet, while the stacking wheel rotates, the stacking wheel receives between blades the paper sheet transported by the transport unit to discharge and stack in the stacking unit, and
when pressing the paper sheet, while the stacking wheel rotates, the stacking wheel presses the paper sheet being stacked inside the stacking unit in a direction going away from the stacking wheel.

5. The paper sheet handling apparatus as claimed in claim 3, wherein the rotating member includes
a shaft member supported on a rotation axis;
an arm member that extends in a diameter direction of the shaft member; and
a patting member arranged at a far tip end in a diameter direction of the arm member.

6. The paper sheet handling apparatus as claimed in claim 3, wherein the control unit controls a rotational frequency of the rotating member.

7. The paper sheet handling apparatus as claimed in claim 6, wherein the control unit changes the rotational frequency of the rotating member between when stacking the paper sheet in the stacking unit and when pressing the paper sheet pushed by the pushing member.

8. The paper sheet handling apparatus as claimed in claim 3, wherein the control unit controls a rotation direction of the rotating member.

9. The paper sheet handling apparatus as claimed in claim 1, wherein the pushing member and the pressing member are drivable while the transport unit is not operated.

10. The paper sheet handling apparatus as claimed in claim 1, further comprising:
a first driving mechanism that drives the transport unit;
a second driving mechanism that drives the pushing member; and
a third driving mechanism that drives the pressing member.

11. The paper sheet handling apparatus as claimed in claim 1, wherein
the stacking unit is provided in plurality,
the pushing member and the pressing member are provided in each stacking unit, and
the control unit separately controls driving each pushing member and each pressing member.

12. The paper sheet handling apparatus as claimed in claim 11, further comprising
an operation unit that receives an instruction operation,
wherein the control unit controls driving the pushing member and the pressing member based on the instruction operation received in the operation unit.

13. The paper sheet handling apparatus as claimed in claim 11, wherein the control unit controls driving the pushing member and the pressing member based on a status of paper sheet handling.

14. The paper sheet handling apparatus as claimed in claim 1, wherein
the pressing member moves between a pressing position at which the pressing member presses the paper sheet present inside the stacking unit and a retracted position at which the pressing member is retracted from inside of the stacking unit, and
the control unit controls moving the pressing member to the retracted position while the paper sheet is being stacked in the stacking unit and moving the pressing member from the retracted position to the pressing position when the pushing member pushes the paper sheet.

15. The paper sheet handling apparatus as claimed in claim 14, wherein a part of the pressing member in contact with the paper sheet is formed by an elastic member.

16. The paper sheet handling apparatus as claimed in claim 14, wherein a part of the pressing member in contact with the paper sheet is formed by a rotating member rotatable in a direction of pushing of the paper sheet by the pushing member.

17. The paper sheet handling apparatus as claimed in claim 1, wherein the pressing member presses the paper sheet by applying wind pressure on the paper sheet.

18. The paper sheet handling apparatus as claimed in claim 1, further comprising
a detection unit that detects a stacking state of the paper sheet stacked in the stacking unit,
wherein the control unit determines whether pressing of the paper sheet is necessary or not based on a detection result by the detection unit and drives the pressing member when the pressing of the paper sheet is necessary.
